(19) United States
(12) Patent Application Publication
(10) Pub. No.: US 2015/0255188 A1
(43) Pub. Date: Sep. 10, 2015

(54) CONDUCTIVE SHAFT AND CONDUCTIVE ROLL FOR OA EQUIPMENT USING THE SHAFT, AND METHOD OF PRODUCING CONDUCTIVE SHAFT

(71) Applicant: Sumitomo Riko Company Limited, Komaki-shi (JP)

(72) Inventors: Naoki Oyaizu, Komaki-shi (JP); Koji Mizutani, Ichinomiya-shi (JP); Junichiro Suzuki, Komaki-shi, Aichi (JP); Kazutaka Katayama, Kasugai-shi (JP); Motoshige Hibino, Komaki-shi (JP)

(73) Assignee: SUMITOMO RIKO COMPANY LIMITED, Komaki-shi (JP)

(21) Appl. No.: 14/719,691

(22) Filed: May 22, 2015

Related U.S. Application Data
(63) Continuation of application No. PCT/JP2014/072680, filed on Aug. 29, 2014.

(30) Foreign Application Priority Data
Aug. 30, 2013 (JP) 2013-179194

(51) Int. Cl. H01B 1/24; B29C 70/02; G03G 15/00

(52) U.S. Cl. CPC H01B 1/24; G03G 15/75; B29C 70/021; B29K 2301/10

(57) ABSTRACT

Provided is a shaft made of a fiber-reinforced resin, in which a continuous glass fiber bundle is embedded in parallel with a lengthwise direction of the shaft, the shaft including a matrix resin formed of a resin composition comprising (A) a thermosetting resin as a main component, (B) carbon black, (C) a dispersant having a basic functional group, and (D) a curing agent for the component (A), in which the component (B) is particulate and is distributed along continuous glass fibers constituting the continuous glass fiber bundle. Thus, there can be provided a conductive shaft that is lightweight, has high strength, is excellent in conductivity, and is inexpensive, and a conductive roll for OA equipment using the shaft, and a method of producing the conductive shaft.

### RELATED APPLICATION

This application is a continuation of International Application No. PCT/JP2014/72680, filed on Aug. 29, 2014, which claims priority to Japanese Patent Application No. 2013-179194, filed on Aug. 30, 2013, the entire contents of each of which are hereby incorporated by reference.

### BACKGROUND

1. Technical Field

The present invention relates to a conductive shaft formed of a fiber-reinforced plastic (FRP) and a conductive roll for OA equipment using the shaft, and a method of producing the conductive shaft.

2. Description of the Related Art

A shaft made of a metal such as iron is typically used in a conductive roll (such as a charging roll or a developing roll) for office automation (OA) equipment such as an electrophotographic copying machine, a printer, and a facsimile. In addition, the shaft is typically subjected to a plating treatment for corrosion prevention. The reason why the shaft made of a metal is used in the conductive roll as described above is that high-precision processability and conductivity involved in a charging mechanism are required.

However, concern has been raised in that the plating applied to the shaft is liable to peel owing to, for example, rubbing between shafts at the time of their transportation or rubbing with abrasive powder, and the peeling results in the corrosion of the shaft.

In addition, the weight reduction of the shaft has been required so that the shaft may be easily transported. Further, the demagnetization of the shaft has been required so that the meters of an aircraft may not be adversely affected during its air transportation. Further, there has been the following environmental demand. It is wished that the amount of an environmental load substance incorporated in a trace amount into the plating should be reduced to the extent possible.

In view of the foregoing, a conductive roll using a shaft made of a resin as its shaft instead of the shaft made of a metal has been proposed in recent years (see JP-A-2003-195601). That is, the shaft is made of a resin, and hence is free of heavy metals and the like, and does not rust. In addition, the shaft is lightweight.

Accordingly, the shaft can eliminate the problems of the shaft made of a metal.

### SUMMARY OF THE INVENTION

However, the shaft made of a resin involves problems in terms of strength and rigidity. In addition, its conductivity is lower than that of the shaft made of a metal and hence an electrical loss is large. Accordingly, a problem occurs in that the shaft cannot be put into practical use as a shaft for a conductive roll. In addition, when conductivity is imparted to the shaft made of a resin, an approach involving adding a conductive filler such as carbon black to a resin composition as a material for the shaft to improve its conductivity is typically employed. However, when the addition amount of the filler is increased for improving the conductivity, a problem occurs in that the viscosity of the resin composition increases to make it difficult to mold the composition. In particular, when the shaft is produced by injection molding like the shaft disclosed in Patent Literature 1, the addition of a large amount of the carbon black extremely increases the viscosity of the resin composition to the extent that the injection molding becomes difficult. Accordingly, it is difficult to express the conductivity through the addition of a large amount of the carbon black. In addition, the carbon black has a high cost benefit because the carbon black is inexpensive among conductive fillers, but the carbon black has small particles and a large surface area as compared with other conductive fillers. Accordingly, a problem occurs in that the carbon black is liable to aggregate or reaggregate, and as a result, the conductivity is hardly expressed.

In view of the foregoing, the inventors of the present invention have made examinations on a shaft made of a fiber-reinforced plastic (FRP) using only a carbon fiber (CF) having conductivity as a reinforcing material. However, a problem occurs in that the carbon fiber (CF) is extremely costly and hence largely affects the unit price of a product.

The present invention has been made in view of such circumstances, and an object of the present invention is to provide a conductive shaft that is lightweight, has high strength, is excellent in conductivity, and is inexpensive, and a conductive roll for OA equipment using the shaft, and a method of producing the conductive shaft.

In order to achieve the above-mentioned object, a first aspect of the present invention resides in a conductive shaft made of a fiber-reinforced resin in which a continuous glass fiber bundle is embedded in parallel with a lengthwise direction of the shaft, the shaft including a matrix resin formed of a resin composition comprising (A) a thermosetting resin as a main component, (B) carbon black, (C) a dispersant having a basic functional group, and (D) a curing agent for the component (A), in which the component (B) is particulate and is distributed along continuous glass fibers constituting the continuous glass fiber bundle, and a second aspect of the present invention resides in a conductive roll for OA equipment, including the conductive shaft as its shaft.

Further, a third aspect of the present invention resides in a method of producing the conductive shaft, including: drawing continuous glass fibers in a bundled state into a tank containing a resin composition comprising (A) a thermosetting resin as a main component, (B) carbon black, (C) a dispersant having a basic functional group, and (D) a curing agent for the component (A); impregnating the continuous glass fibers with the resin composition; drawing the fibers after the impregnation into a die, followed by thermal curing; and cutting an elongated fiber-reinforced resin molded article thus obtained into a predetermined length.

That is, the inventors of the present invention have made extensive studies to solve the problems. In the process of the studies, the inventors of the present invention have made examinations on the following: a shaft is made of a fiber-reinforced resin, a continuous fiber bundle formed of glass fibers (GF) having higher cost benefits than those of carbon fibers (CF) is used as fibers serving as a reinforcing material for the shaft, the continuous glass fiber bundle is allowed to be embedded in parallel with the lengthwise direction of the shaft, and carbon black is incorporated into the matrix resin of the shaft for imparting conductivity. However, when the carbon black is used, such problems concerning moldability and the impartment of the conductivity as described in the foregoing need to be solved. In view of the foregoing, the inventors of the present invention have made additional studies, and have adopted a matrix resin composition comprising the thermosetting resin (A) as a main component, and the dispersant (C) having a basic functional group. As a result, the inventors have found that the basic functional group of the dispersant (C) interacts with an acidic functional group of the carbon black (B) to improve the dispersibility of the carbon black (B), and hence the carbon black (B) enters a gap between the continuous glass fiber bundles to be arrayed. The inventors have found that in accordance with the foregoing, the carbon black (B) is particulate and is distributed along the continuous glass fibers constituting the continuous glass fiber bundle, and an electrical path route can be formed with a small carbon black amount without any increase in viscosity of the composition, and as a result, a conductive shaft capable of achieving the desired object is obtained. Thus, the inventors have reached the present invention.

It should be noted that it is difficult for injection molding like a conventional one to form the electrical path route with a small carbon black amount as described above. In view of the foregoing, the inventors of the present invention have found that applying the following special production method eliminates the problems and hence enables satisfactory production of such special conductive shaft as described in the foregoing: the continuous glass fibers are drawn in a bundled state into a tank containing the matrix resin composition, the continuous glass fibers are impregnated with the resin composition, the fibers after the impregnation are drawn into a die and thermally cured, and an elongated fiber-reinforced resin molded article thus obtained is cut into a predetermined length.

As described above, the conductive shaft of the present invention is the shaft made of a fiber-reinforced resin, in which the continuous glass fiber bundle is embedded in parallel with the lengthwise direction of the shaft, the shaft including the matrix resin formed of the resin composition comprising the thermosetting resin (A) as a main component, and the carbon black (B), the specific dispersant (C), and the curing agent (D), in which the carbon black (B) is particulate and is distributed along the continuous glass fibers constituting the continuous glass fiber bundle. Accordingly, the conductive shaft that is lightweight, has high strength, is excellent in conductivity, and is inexpensive can be obtained. In addition, the conductive roll for OA equipment using the conductive shaft expresses excellent roll performance as in a roll using a conventional shaft made of a metal, and can obtain an operation and effect by virtue of the use of the conductive shaft such as a weight reduction.

In addition, an electrical path route can be formed with a small carbon black amount and the conductive shaft of the present invention can be satisfactorily produced by the following special production method: the continuous glass fibers are drawn in a bundled state into a tank containing the resin composition, the continuous glass fibers are impregnated with the resin composition, the fibers after the impregnation are drawn into a die and thermally cured, and an elongated fiber-reinforced resin molded article thus obtained is cut into a predetermined length.

### BRIEF DESCRIPTION OF DRAWINGS

FIG. 1 is a schematic view illustrating the state of a section of a conductive shaft of the present invention.

FIG. 2 is a schematic view illustrating the state of a section of a comparative shaft.

### DETAILED DESCRIPTION

Next, an embodiment of the present invention is described in detail.

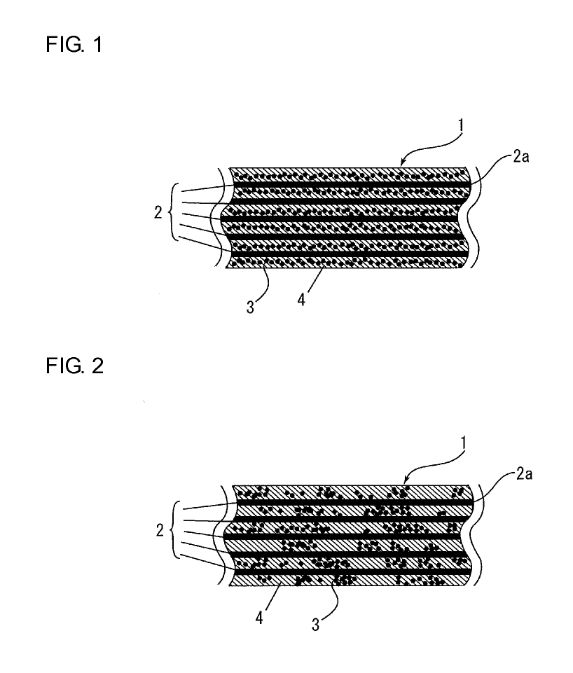

As described in the foregoing, a conductive shaft of the present invention is a shaft made of a fiber-reinforced resin, in which a continuous glass fiber bundle is embedded in parallel with the lengthwise direction of the shaft, the shaft includes a matrix resin formed of a resin composition comprising a thermosetting resin (A) as a main component, and carbon black (B), a specific dispersant (C), and a curing agent (D), and the carbon black (B) is particulate and is distributed along continuous glass fibers constituting the continuous glass fiber bundle. Here, the “main component” of the resin composition refers to a component that largely affects the characteristics of the entirety of the composition, and in the present invention, means a component accounting for 50 wt % or more of the entirety. In addition, the phrase “the carbon black (B) is particulate and is distributed along continuous glass fibers constituting the continuous glass fiber bundle” means a state where the aggregation of the carbon black is not observed and an electrical path route is formed by the carbon black along the continuous glass fibers, and hence the conductivity of the shaft is secured. FIG. 1 schematically illustrates the state. In the figure, reference symbol 1 represents a shaft, reference symbol 2 represents a glass fiber bundle, reference symbol 2a represents a glass fiber constituting the bundle, reference symbol 3 represents carbon black, and reference symbol 4 represents a matrix resin. The distribution state of the carbon black can be confirmed by observing a section of the conductive shaft with an electron microscope. However, in ordinary cases, the carbon black can be regarded as being in such distribution state as described above when the blending ratio of the carbon black in the resin composition as a material for the matrix resin falls within a range to be described later and the electrical resistance value of the conductive shaft shows a low value as described later. It should be noted that FIG. 2 is a figure for comparison and illustrates a situation where the carbon black is not in such distribution state as described above and aggregates.

In the conductive shaft of the present invention, the glass fibers need to be continuous fibers as described above from the viewpoints of strength and rigidity, and the fibers are bundled as described above. It should be noted that a glass fiber content (Vf value) in the conductive shaft of the present invention determined from the following calculation equation (1) is preferably from 40 to 70%, more preferably from 55 to 65%. This is because of the following reasons: when the Vf value is excessively small, the mold shrinkage of the shaft is large and hence a product having no surface smoothness may be obtained; and on the other hand, when the Vf value is excessively large, the amount of the resin reduces and hence it may be unable to secure the conductivity.

Vf=[(V−Vm)/V]×100 (1)

V: Volume of conductive shaft
Vm: Volume of matrix resin in conductive shaft

In addition, examples of the thermosetting resin (A) constituting the resin composition as a material for the matrix resin in the conductive shaft of the present invention include an unsaturated polyester resin, a vinyl ester resin, an epoxy resin, and a phenol resin. One kind of those resins is used alone, or two or more kinds thereof are used in combination. Of those, an unsaturated polyester resin is preferred from the viewpoint of adhesiveness with the glass fibers.

As the curing agent (D) for the thermosetting resin (A), for example, the following organic peroxides are used for the unsaturated polyester resin and the vinyl ester resin: methyl ethyl ketone peroxide, acetylacetone peroxide, benzoyl peroxide, t-butyl peroxy-2-ethylhexanoate, benzoyl peroxide, t-butyl perbenzoate, and dicumyl peroxide. For example, the following substances are used for the epoxy resin: bisphenol A, tetrabromobisphenol A, bisphenol S, bisphenol F, bis(4-hydroxyphenyl)cyclohexane, bis(4-hydroxyphenyl) ethane, 1,3,3-trimethyl-1-m-hydroxyphenylindan-5-ol, 1,3,3-trimethyl-1-m-hydroxyphenylindan-7-ol, 1,3,3-trimethyl-1-p-hydroxyphenylindan-6-ol, resorcin, hydroquinone, catechol, polycarboxylic acids such as nadic acid, maleic acid, phthalic acid, methyl-tetrahydrophthalic acid, and methylnadic acid, and anhydrides thereof; polyamine compounds such as diaminodiphenylmethane, diaminodiphenyl sulfone, diaminodiphenyl ether, phenylenediamine, diaminodicyclohexylmethane, xylylenediamine, toluenediamine, diaminodicyclocyclohexane, dichloro-diaminodiphenylmethane (including an isomer thereof), ethylenediamine, and hexamethylenediamine; dicyandiamide; tetramethylguanidine; and a compound containing active hydrogen capable of reacting with an epoxy group. For example, the following substances are used for the phenol resin: hexamethylenetetramine, methylolmelamine, and methylolurea. One kind of those substances is used alone, or two or more kinds thereof are used in combination. The ratio of the curing agent (D) in the resin composition falls within the range of preferably from 0.5 to 15 parts by weight, more preferably from 1 to 10 parts by weight with respect to 100 parts by weight of the thermosetting resin (A) from the viewpoint of its curing property.

The carbon black (B) to be used together with the thermosetting resin (A) has an average particle diameter (primary particle diameter) of preferably from 18 to 122 nm, more preferably from 27 to 43 nm from the viewpoint of the wettability of the resin. In addition, the carbon black (B) to be used has a DBP oil absorption of preferably from 42 to 495 m²/g, more preferably from 160 to 360 m²/g from the viewpoint of the conductivity (the formation of the electrical path route). It should be noted that the DBP oil absorption is specified in JIS K6217 and such carbon black as described above is specifically, for example, acetylene black or ketjen black. One kind of those carbon blacks is used alone, or two or more kinds thereof are used in combination. Of those, acetylene black is preferred from the viewpoints of the wettability of the resin and the conductivity (the formation of the electrical path route).

The ratio of the carbon black (B) in the resin composition preferably falls within the range of from 5 to 15 parts by weight with respect to 100 parts by weight of the thermosetting resin (A). This is because of the following reasons: when the blending amount of the carbon black (B) is excessively small, sufficient conductivity is not obtained; and on the other hand, when the blending amount of the carbon black (B) is excessively large, the viscosity of the resin composition increases, and hence the inside of the fiber bundle is not completely impregnated with the resin composition, and a reduction in moldability of the shaft and an adverse effect on the conductivity are observed.

A dispersant having a basic functional group is used as the specific dispersant (C) to be used together with the thermosetting resin (A) and the carbon black (B). Here, a dispersant that adsorbs to the surface of the carbon black (B) to improve its dispersibility in the thermosetting resin (A) and to suppress the reaggregation of the carbon black (B) with time is used as the “dispersant” in the present invention. The basic functional group in the dispersant is, for example, an amino group or an amine group because any such group easily acts on the carbon black (B).

In addition, the dispersant (C) preferably further has a structure having an affinity for the thermosetting resin (A) from the viewpoint of additionally improving the dispersion stability of the carbon black (B). It should be noted that the “structure having an affinity for the thermosetting resin (A)” varies depending on the kind of the thermosetting resin (A). For example, when an unsaturated polyester resin and a vinyl ester resin are each used as the thermosetting resin (A), a dispersant having a high-molecular weight polymer component such as a boric acid ester, an alkyl ammonium salt of a polycarboxylic acid, an unsaturated polycarboxylic acid polymer, or a salt of an unsaturated aliphatic polyamine amide and an acidic ester is used as the dispersant (C). In addition, when an epoxy resin and a phenol resin are each used as the thermosetting resin (A), a dispersant having a high-molecular weight polymer component such as an alkyl ammonium salt of a polycarboxylic acid, an unsaturated polycarboxylic acid polymer, or a salt of an unsaturated aliphatic polyamine amide and an acidic ester is used as the dispersant (C).

It should be noted that even when the dispersant (C) does not have a structure having an affinity for the thermosetting resin (A), the same effect as that described above (stabilizing effect on the dispersion of the carbon black (B)) can be obtained by separately using a dispersant having a structure having an affinity for the thermosetting resin (A) (dispersant that does not correspond to the dispersant (C)) in combination with the dispersant (C). It should be noted that when such dispersant is used, its ratio preferably falls within the range of from 1.45 to 3.78 parts by weight with respect to 100 parts by weight of the thermosetting resin (A).

In addition, examples of the dispersant (C) include commercial products such as BYK-9076 (alkylammonium salt) manufactured by BYK and SOLSPERSE 5000 (copper phthalocyaninesulfonic acid ammonium salt) manufactured by Lubrizol Japan Limited.

In addition, a commercial product of the dispersant that has a structure having an affinity for the thermosetting resin (A) but does not have a basic functional group is, for example, SOLSPERSE 88000 manufactured by Lubrizol Japan Limited.

When the dispersant (C) is used alone, its ratio in the resin composition preferably falls within the range of from 5 to 15 parts by weight with respect to 100 parts by weight of the thermosetting resin (A). However, when the dispersant (C) is used in combination with the dispersant that has a structure having an affinity for the thermosetting resin (A) but does not have a basic functional group as described above, the ratio of the dispersant (C) preferably falls within the range of from 1.45 to 3.78 parts by weight with respect to 100 parts by weight of the thermosetting resin (A). This is because of the following reasons: when the blending amount of the dispersant (C) is excessively small, the viscosity of the resin composition increases, and hence sufficient dispersion stability of the carbon black (B) is not obtained and desired conductivity cannot be expressed; and on the other hand, when the blending amount of the dispersant (C) is excessively large, a redundant dispersant that does not act on the carbon black (B) is present, and hence an interval between the particles of the carbon black distributed along the fiber bundle becomes so wide that the desired conductivity cannot be expressed.

It should be noted that the following agents may be added to the resin composition as appropriate: a curing (crosslinking) accelerator, a curing (crosslinking) accelerator activator, an aid, a plasticizer, an antioxidant, a shrink-proofing agent, an antiozonant, an antifoaming agent, an antisagging agent, an organic solvent, inorganic fillers (talc, mica, calcium carbonate, kaolin, wollastonite, and a milled fiber), and the like.

Next, the conductive shaft of the present invention is produced, for example, as described below.

That is, the continuous glass fibers are drawn in a bundled state into a tank containing the resin composition comprising the thermosetting resin (A) as a main component, and the curing agent (D) therefor, the carbon black (B), and the specific dispersant (C), the continuous glass fibers are impregnated with the resin composition, the fibers after the impregnation are drawn into a die and thermally cured, and an elongated fiber-reinforced resin molded article thus obtained is cut into a predetermined length. In addition, when the continuous glass fibers are drawn into the die after their impregnation with the resin composition, a nonwoven fabric (a polyester-, glass-, or aramid-based material is available as a material therefor) may be set for suppressing the exposure of the fibers to the surface of the shaft. Such special production method enables the formation of an electrical path route with a small carbon black amount and hence enables satisfactory production of the target conductive shaft of the present invention.

In particular, the resin composition to be used in the impregnation treatment is preferably subjected to a kneading treatment with a triple roll because the aggregation of the carbon black is additionally alleviated and the conductivity of the conductive shaft to be obtained can be additionally improved. It should be noted the kneading treatment is performed before the addition of the curing agent and the kneading is performed again after the addition of the curing agent, and the kneading at this time may be any one of the following treatments because the curing agent only needs to be mixed in the resin composition: hand stirring, blade stirring, and kneading with a roll. Of those, blade stirring is preferred because of its simplicity.

In addition, the viscosity of the resin composition to be used in the impregnation treatment is preferably set to fall within the range of from 0.5 to 60 Pa·s because the special production method can be satisfactorily performed. It should be noted that the viscosity is measured before the addition of the curing agent, and is a value measured in conformity with JIS K7117 with a B-type viscometer at a temperature of room temperature (28° C. to 35° C.).

The thermal curing of the resin composition subjected to the impregnation treatment in the die is performed by a heat treatment at from 100 to 160° C. for from about 1 to 15 minutes.

The elongated fiber-reinforced resin molded article obtained by the thermal curing in the die is cut into the predetermined length with a cutting machine or the like. Thus, the target conductive shaft is obtained.

It should be noted that the series of production processes can be performed with a general pultrusion molding machine.

In addition, it is preferred that a conductive coating layer formed of metal plating, metal powder, or graphite be appropriately formed on the surface of the shaft. This is because of the following reason: the formation of the conductive coating layer as described above eliminates the possibility that the continuous glass fibers are exposed to the surface of the shaft, facilitates the expression of the conductivity of the surface of the shaft, and improves the bending rigidity of the shaft. In addition, the carbon black amount of the resin composition to be used in the impregnation treatment with the continuous glass fibers at the time of the production of the shaft can be additionally suppressed by compensating the conductivity of the shaft with the conductive coating layer. As a result, an increase in viscosity of the resin composition can be suppressed and hence the pultrusion molding of the shaft is additionally facilitated. Accordingly, the productivity of the shaft can be additionally improved. It should be noted that the conductive coating layer, which may be formed only on the outer peripheral surface (side surface) of the shaft, is preferably formed on the surface of an end portion of the shaft, in other words, a cut surface of the shaft as well. This is because when the conductive coating layer is formed on the surface of the end portion of the shaft as well as described above, conductivity between the end portion and outer peripheral surface of the shaft is satisfactorily expressed. By the way, the surface of the shaft is meant to include both the outer peripheral surface of the shaft and the surface of the end portion of the shaft.

When the conductive coating layer is formed of metal plating, the layer can be formed by subjecting the surface of the shaft to electroplating or electroless plating such as zinc-nickel plating or nickel plating in accordance with an ordinary method. In addition, when the conductive coating layer is formed of metal powder or graphite, the conductive coating layer can be formed by applying, onto the surface of the shaft, an application liquid obtained by dispersing metal powder formed of, for example, SUS or aluminum, or graphite powder in an organic solvent, and drying the liquid. It should be noted that the conductive coating layer may be formed as described above by using the application liquid obtained by mixing and dispersing the metal powder and the graphite powder. In addition, a resin binder such as a urethane, epoxy, acrylic, or polyester resin may be appropriately incorporated into the application liquid from the viewpoint of improving the strength of a coating film, but in terms of conductivity, it is preferred that such resin binder be not incorporated. In addition, the fixability of the conductive coating layer may be improved by roughening the surface of the shaft before the coating through an etching treatment in advance. The etching treatment is performed by a chemical treatment with an alkaline solution, a hydrofluoric acid solution, or the like, or a physical treatment based on wet blasting or the like.

The conductive shaft of the present invention obtained as described above preferably has an electrical resistance value of less than 1×10⁶Ω because the shaft can sufficiently exhibit its function as a shaft for a conductive roll for OA equipment.

In addition, a conductive roll for OA equipment using the conductive shaft of the present invention as its shaft can exhibit an excellent function as a conductive roll (in particular, a charging roll or a developing roll) for OA equipment by virtue of the performance of the shaft.

It should be noted that the conductive shaft of the present invention can exhibit excellent performance as a shaft for a roll for OA equipment such as a toner-supplying roll, a sheet-feeding roll, a transfer roll, or a cleaning roll in addition to the charging roll and the developing roll. In addition, the conductive shaft of the present invention can find use in, for example, shafts for industrial rolls such as a dust-resistant roll and an engraved roll, and structural members for various products.

### EXAMPLES

Next, Examples are described together with Comparative Examples. However, the present invention is not limited to these examples, and other examples are permitted as long as the other examples do not deviate from the gist of the present invention.

First, the following materials were prepared prior to Examples and Comparative Examples.

[Thermosetting Resin (A1)]

Unsaturated polyester resin (U-PICA 3140 manufactured by Japan U-Pica Company Ltd.)

[Carbon Black (B1)]

DENKA BLACK (average particle diameter: 35 nm, DBP oil absorption: 160 ml/100 g) manufactured by Denki Kagaku Kogyo Kabushiki Kaisha

[Carbon Black (B2)]

SEAST TA (average particle diameter: 122 nm, DBP oil absorption: 42 ml/100 g) manufactured by Tokai Carbon Co., Ltd.

[Dispersant (C1)]

Alkylammonium salt (BYK-9076 manufactured by BYK)

[Dispersant (C2)]

Copper phthalocyaninesulfonic acid ammonium salt (SOLSPERSE 5000 manufactured by Lubrizol Japan Limited)

[Dispersant (C3)]

SOLSPERSE 88000 manufactured Lubrizol Japan Limited

[Dispersant (C4) (for Comparative Examples)]

Copolymer having an acid group (BYK-W9010 manufactured by BYK)

[Dispersant (C5) (for Comparative Examples)]

Block copolymer having a globular structure (DISPERBYK-2155 manufactured by BYK)

[Curing Agent (D1)]

PEROYL TCP manufactured by NOF Corporation

### Examples 1 to 9 and Comparative Examples 1 to 3

The thermosetting resin and a dispersant were blended, and the mixture was subjected to blade stirring. After that, carbon black was added to the mixture and the whole was kneaded with a triple roll. After that, the curing agent was added to the kneaded product and the mixture was subjected to blade stirring. Thus, a resin composition was prepared. It should be noted that the blending ratios of the respective components and a triple roll gap at the time of the kneading were as shown in Tables 1 and 2 to be described later.

Subsequently, continuous glass fibers were drawn in a bundled state into a tank containing the prepared resin composition, and the continuous glass fibers were impregnated with the resin composition. After that, the fibers were drawn into a die and thermally cured, and an elongated fiber-reinforced resin molded article thus obtained was cut. Thus, a shaft having a diameter of 6 mm and a length of 300 mm was produced. It should be noted that the shaft was produced so that the glass fiber content (Vf value) of the shaft determined from the following calculation equation (1) was as shown in Table 1 or 2 to be described later.

Vf=[(V−Vm)/V]×100 (1)

V: Volume of shaft
Vm: Volume of matrix resin in shaft

The respective characteristics of the shafts of Examples and Comparative Examples thus obtained were measured and evaluated in accordance with the following criteria. The results are collectively shown in Tables 1 and 2 to be described later.

[Viscosity Measurement]

The viscosity of a resin composition after kneading with a triple roll (viscosity before the addition of the curing agent) was measured under the following conditions.

Apparatus: manufactured by Toki Sangyo Co., Ltd., VISCOMETER TVB-10 (TVR)

Rotor type: H7

Number of revolutions: 60 rpm

Measurement environment: room temperature (28° C. to 35° C.)

[Electrical Resistance Value Measurement]

A numerical value for an electrical resistance value varies depending on the shapes (sectional area and length) of an evaluation object. Accordingly, the shapes of the shafts were standardized to a diameter of 6 mm and a length of 300 mm, and their electrical resistance values were measured with a tester (MODEL 3021 manufactured by Hioki E.E. Corporation). The measurement was performed by bringing a measuring needle into contact with a section of an end portion of a shaft of the foregoing shape. Then, a shaft having an electrical resistance value of less than 1×10³Ω was evaluated as ⊚, a shaft having an electrical resistance value of 1×10³Ω or more and less than 1×10⁶Ω was evaluated as o, and a shaft having an electrical resistance value of 1×10⁶Ω or more was evaluated as x.

TABLE 1
(Part (s) by weight)

| | | Example | | | | | |
|---|---|---|---|---|---|---|---|
| | | 1 | 2 | 3 | 4 | 5 | 6 |
| Thermo- | A1 | 100 | 100 | 100 | 100 | 100 | 100 |
| setting | | | | | | | |
| resin | | | | | | | |
| Carbon | B1 | 5 | 10 | 10 | 12.5 | 12.5 | 12.5 |
| black | B2 | — | — | — | — | — | — |
| Dispersant | C1 | 5 | 10 | — | — | — | — |
| | C2 | — | — | 1.89 | 1.89 | 1.89 | 1.89 |
| | C3 | — | — | 1.89 | 1.89 | 1.89 | 1.89 |
| | C4 | — | — | — | — | — | — |
| | C5 | — | — | — | — | — | — |
| Curing | D1 | 10 | 10 | 10 | 10 | 10 | 10 |
| agent | | | | | | | |

| | | | | | | |
|---|---|---|---|---|---|---|
| Triple roll gap | 0.1 | 0.1 | 0.15 | 0.15 | 0.15 | 0.15 |
| at the time of | | | | | | |
| kneading (mm) | | | | | | |
| Vf value (%) | 55 | 55 | 55 | 55 | 42 | 70 |
| Viscosity (Pa · s) | 4.6 | 18.9 | 6.5 | 8.2 | 8.2 | 8.2 |
| Electrical | 4 × 10⁴ | 2 × 10⁴ | 2 × 10⁴ | 3 × 10³ | 4 × 10³ | 4 × 10³ |
| resistance | | | | | | |
| value (Ω) | | | | | | |
| Evaluation | ∘ | ∘ | ∘ | ∘ | ∘ | ∘ |

TABLE 2
(Part (s) by weight)

| | | | | | Comparative | | |
|---|---|---|---|---|---|---|---|
| | | Example | | | Example | | |
| | | 7 | 8 | 9 | 1 | 2 | 3 |
| Thermo- | A1 | 100 | 100 | 100 | 100 | 100 | 100 |
| setting | | | | | | | |
| resin | | | | | | | |
| Carbon | B1 | 15 | 15 | 6.64 | 5 | 5 | 5 |
| black | B2 | — | — | 14.06 | — | — | — |
| Dispersant | C1 | — | 15 | — | — | — | — |
| | C2 | 1.89 | — | 1.45 | — | — | — |
| | C3 | 1.89 | — | 1.45 | — | — | — |
| | C4 | — | — | — | — | 5 | — |
| | C5 | — | — | — | — | — | 5 |
| Curing | D1 | 10 | 10 | 10 | 10 | 10 | 10 |
| agent | | | | | | | |

| | | | | | | |
|---|---|---|---|---|---|---|
| Triple roll gap | 0.15 | 0.1 | 0.15 | 0.1 | 0.1 | 0.1 |
| at the time of | | | | | | |
| kneading (mm) | | | | | | |
| Vf value (%) | 55 | 55 | 55 | 55 | 55 | 55 |
| Viscosity (Pa · s) | 58.1 | 55 | 3.1 | 38.1 | 38.0 | 35.1 |
| Electrical | 2 × 10⁴ | 5 × 10⁴ | 7 × 10³ | 1 × 10⁶ | 1 × 10⁶ | 1 × 10⁶ |
| resistance | | | | or | or | or |
| value (Ω) | | | | more | more | more |
| Evaluation | ∘ | ∘ | ∘ | × | × | × |

The foregoing results show that the shafts of Examples 1 to 9 have lower electrical resistance values than those of the shafts of Comparative Examples, and hence the former shafts are more excellent in conductivity than the latter shafts are. It should be noted that when the blending amount of the carbon black was further increased in each of Comparative Examples, an abrupt increase in viscosity of the resin composition (60 Pa·s or more) was observed, and hence the shaft could not be produced by applying the molding method of any one of Examples and Comparative Examples.

### Example 10

A conductive coating layer was formed on the entirety of the surface of a shaft produced in the same manner as in Example 1 by the following coating treatment 1.

### [Coating Treatment 1]

First, the shaft was subjected to an etching treatment with a 200 g/L aqueous solution of NaOH at a temperature of 40° C. for 10 minutes. Next, the shaft was immersed in a Pd catalyst-providing agent (OPC-50 INDUCER manufactured by Okuno Chemical Industries Co., Ltd.) at 40° C. for 5 minutes. Thus, its surface was provided with a Pd catalyst. Subsequently, the shaft was immersed in an activator (OPC-150 CRYSTER manufactured by Okuno Chemical Industries Co., Ltd.) at 25° C. for 5 minutes. Thus, a Pd ion was metallized (activation treatment). After the entirety of the surface of the shaft had been subjected to a pre-plating treatment as described above, the shaft was immersed in an electroless nickel plating liquid (TMP CHEMICAL NICKEL HRT manufactured by Okuno Chemical Industries Co., Ltd.) at 40° C. for 10 minutes. Thus, an electroless nickel plating layer (conductive coating layer) having a thickness of 0.5 μm was formed.

### Example 11

A conductive coating layer was formed on the entirety of the surface of a shaft produced in the same manner as in Example 4 by the coating treatment 1.

### Example 12

A conductive coating layer was formed on the entirety of the surface of a shaft produced in the same manner as in Example 6 by the coating treatment 1.

### Example 13

A conductive coating layer was formed on the entirety of the surface of a shaft produced in the same manner as in Example 6 by the following coating treatment 2. [Coating Treatment 2]

The entirety of the surface of the shaft was sprayed with a spraying agent obtained by dispersing graphite powder in an organic solvent such as isopropanol or dimethyl ether (Graphite Spray manufactured by Fine Chemical Japan), and the spraying agent was dried at room temperature for about 1 hour. After that, the spraying agent was further dried at 60° C. Thus, a conductive coating layer was formed.

### Example 14

A conductive coating layer was formed on the entirety of the surface of a shaft produced in the same manner as in Example 6 by the following coating treatment 3.

### [Coating Treatment 3]

The entirety of the surface of the shaft was sprayed with a spraying agent obtained by dispersing SUS powder in an organic solvent such as toluene or dimethyl ether (Stainless Spray manufactured by Fine Chemical Japan), and the spraying agent was dried at room temperature for about 1 hour. After that, the spraying agent was further dried at 60° C. Thus, a conductive coating layer was formed.

### Example 15

A conductive coating layer was formed on the entirety of the surface of a shaft produced in the same manner as in Example 6 by the following coating treatment 4.

### [Coating Treatment 4]

The entirety of the surface of the shaft was sprayed with a spraying agent obtained by dispersing aluminum powder in an organic solvent such as toluene or dimethyl ether (Fine Heat Reflector manufactured by Fine Chemical Japan), and the spraying agent was dried at room temperature for about 1 hour. After that, the spraying agent was further dried at 60° C. Thus, a conductive coating layer was formed.

### Example 16

A conductive coating layer was formed on the entirety of the surface of a shaft produced in the same manner as in Example 6 by the following coating treatment 5. [Coating Treatment 5]

The entirety of the surface of the shaft was sprayed with a spraying agent obtained by mixing and dispersing graphite powder and aluminum powder in an organic solvent such as butane or propanol

(NON SEIZE manufactured by Fine Chemical Japan), and the spraying agent was dried at room temperature for about 1 hour. After that, the spraying agent was further dried at 60° C. Thus, a conductive coating layer was formed.

TABLE 3
(Part (s) by weight)

| | | Example | | | | | | |
|---|---|---|---|---|---|---|---|---|
| | | 10 | 11 | 12 | 13 | 14 | 15 | 16 |
| Thermosetting | A1 | 100 | 100 | 100 | 100 | 100 | 100 | 100 |
| resin | | | | | | | | |
| Carbon black | B1 | 5 | 12.5 | 12.5 | 12.5 | 12.5 | 12.5 | 12.5 |
| | B2 | — | — | — | — | — | — | — |
| Dispersant | C1 | 5 | — | — | — | — | — | — |
| | C2 | — | 1.89 | 1.89 | 1.89 | 1.89 | 1.89 | 1.89 |
| | C3 | — | 1.89 | 1.89 | 1.89 | 1.89 | 1.89 | 1.89 |
| | C4 | — | — | — | — | — | — | — |
| | C5 | — | — | — | — | — | — | — |
| Curing agent | D1 | 10 | 10 | 10 | 10 | 10 | 10 | 10 |

| | | | | | | | |
|---|---|---|---|---|---|---|---|
| Coating treatment | Treatment | Treatment | Treatment | Treatment | Treatment | Treatment | Treatment |
| | 1 | 1 | 1 | 2 | 3 | 4 | 5 |
| Triple roll gap at the time | 0.1 | 0.15 | 0.15 | 0.15 | 0.15 | 0.15 | 0.15 |
| of kneading (mm) | | | | | | | |
| Vf value (%) | 55 | 55 | 70 | 70 | 70 | 70 | 70 |
| Viscosity (Pa · s) | 4.6 | 8.2 | 8.2 | 8.2 | 8.2 | 8.2 | 8.2 |
| Electrical resistance | 2 × 10¹ | 1 × 10¹ | 1 × 10¹ | 8 × 10² | 5 × 10² | 6 × 10² | 2 × 10² |
| value (Ω) | | | | | | | |
| Evaluation | ⊚ | ⊚ | ⊚ | ⊚ | ⊚ | ⊚ | ⊚ |

The foregoing results show that the shafts of Examples 10 to 16 have even lower electrical resistance values than those of the shafts of Examples 1 to 9, and hence the former shafts are even more excellent in conductivity than the latter shafts are.

Meanwhile, the bending elastic modulus of each shaft was measured in accordance with the following criteria. As a result, while the bending elastic modulus of Example 1 was 43 GPa, the bending elastic modulus of Example 10 was 46 GPa. While the bending elastic modulus of Example 4 was 43 GPa, the bending elastic modulus of Example 11 was 46 GPa. Further, while the bending elastic modulus of Example 6 was 52 GPa, the bending elastic modulus of Example 12 was 56 GPa. As described above, an increasing effect on a bending elastic modulus was observed by forming a conductive coating layer.

### [Bending Elastic Modulus]

The bending elastic modulus (GPa) of each of the samples of the shafts standardized to a diameter of 6 mm and a length of 125 mm was measured by performing the three-point bending test of the shaft in conformity with JIS K7017 under a temperature of 25° C. (indenter radius: 5 mm, radius of a support: 2 mm, distance between supporting points: 100 mm, testing rate: 50 mm/min).

It should be noted that specific modes in the present invention have been described in the foregoing Examples, but the foregoing Examples are merely illustrative and should not be construed as being limitative. Various modifications apparent to a person skilled in the art are intended to fall within the scope of the present invention.

The conductive shaft of the present invention is lightweight, has high strength, is excellent in conductivity, and is inexpensive. Accordingly, the shaft is preferably used as a shaft for a conductive roll for OA equipment. In addition, the shaft can find use in, for example, a shaft for a roll for OA equipment that is not required to have conductivity, shafts for industrial rolls such as a dust-resistant roll and an engraved roll, and structural members for various products.

What is claimed is:

1. A conductive shaft made of a fiber-reinforced resin, in which a continuous glass fiber bundle is embedded in parallel with a lengthwise direction of the shaft,
the shaft comprising a matrix resin formed of a resin composition comprising:
(A) a thermosetting resin as a main component;
(B) carbon black;
(C) a dispersant having a basic functional group; and
(D) a curing agent for the component (A),
wherein the component (B) is particulate and is distributed along continuous glass fibers constituting the continuous glass fiber bundle.

2. A conductive shaft according to claim 1, wherein the dispersant (C) further has a structure having an affinity for the thermosetting resin (A).

3. A conductive shaft according to claim 1, wherein the thermosetting resin (A) comprises at least one resin selected from the group consisting of an unsaturated polyester resin, a vinyl ester resin, an epoxy resin, and a phenol resin.

4. A conductive shaft according to claim 1, wherein a ratio of the carbon black (B) in the resin composition falls within a range of from 5 to 15 parts by weight with respect to 100 parts by weight of the thermosetting resin (A).

5. A conductive shaft according to claim 1, wherein a ratio of the dispersant (C) in the resin composition falls within a range of from 5 to 15 parts by weight with respect to 100 parts by weight of the thermosetting resin (A).

6. A conductive shaft according to claim 1, wherein the resin composition further contains a dispersant that has a structure having an affinity for the thermosetting resin (A) and is free of a basic functional group.

7. A conductive shaft according to claim 1, wherein:
the resin composition further contains a dispersant that has a structure having an affinity for the thermosetting resin (A) and is free of a basic functional group; and
a ratio of the dispersant (C) in the resin composition falls within a range of from 1.45 to 3.78 parts by weight with respect to 100 parts by weight of the thermosetting resin (A).

8. A conductive shaft according to claim 1, further comprising a conductive coating layer formed of metal plating, metal powder, or graphite, the conductive coating layer being formed on a surface of the conductive shaft.

9. A conductive shaft according to claim 1, wherein the conductive shaft has an electrical resistance value of less than 1×10⁶Ω.

10. A conductive shaft according to claim 1, wherein the thermosetting resin (A) is composed of at least one of an unsaturated polyester resin and a vinyl ester resin, and the dispersant (C) is composed of at least one component selected from the group consisting of a boric acid ester, an alkyl ammonium salt of a polycarboxylic acid, an unsaturated polycarboxylic acid polymer, a salt of an unsaturated aliphatic polyamine amide and an acidic ester.

11. A conductive shaft according to claim 1, wherein the thermosetting resin (A) is composed of at least one of an epoxy resin and a phenol resin, and the dispersant (C) is composed of at least one component selected from the group consisting of an alkyl ammonium salt of a polycarboxylic acid, an unsaturated polycarboxylic acid polymer, and a salt of an unsaturated aliphatic polyamine amide and an acidic ester.

12. A conductive shaft according to claim 1, wherein the thermosetting resin (A) is composed of an unsaturated polyester resin.

13. A conductive shaft according to claim 1, wherein a glass fiber content (Vf value) in the conductive shaft is from 40 to 70%.

14. A conductive shaft according to claim 1, wherein the carbon black (B) has an average particle diameter (primary particle diameter) of from 18 to 122 nm.

15. A conductive shaft according to claim 1, wherein the conductive shaft comprises a shaft for a conductive roll for Office Automation equipment.

16. A conductive roll for Office Automation equipment, comprising the conductive shaft of claim 15 as a shaft.

17. A conductive roll for Office Automation equipment according to claim 16, wherein the conductive roll is used as a charging roll or a developing roll.

18. A method of producing the conductive shaft of claim 1, comprising:
drawing continuous glass fibers in a bundled state into a tank containing a resin composition comprising (A) a thermosetting resin as a main component, (B) carbon black, (C) a dispersant having a basic functional group, and (D) a curing agent for the thermosetting resin (A);
impregnating the continuous glass fibers with the resin composition;
drawing the fibers after the impregnation into a die, followed by thermal curing; and
cutting an elongated fiber-reinforced resin molded article thus obtained into a predetermined length.

19. A method of producing the conductive shaft according to claim 18, wherein the resin composition to be used in the impregnation treatment is subjected to a kneading treatment with a triple roll.

20. A method of producing the conductive shaft according to claim 18, wherein the resin composition to be used in the impregnation treatment has a viscosity in a range of from 0.5 to 60 Pa·s.
